(19) United States
(12) Patent Application Publication
(10) Pub. No.: US 2022/0325135 A1
(43) Pub. Date: Oct. 13, 2022

(54) INK COMPOSITIONS WITH BIODEGRADABLE POLYURETHANE BINDER

(71) Applicant: Hewlett-Packard Development Company, L.P., Spring, TX (US)

(72) Inventors: Zhang-Lin ZHOU, San Diego, CA (US); Or BRANDSTEIN, San Diego, CA (US); Qianhan YANG, San Diego, CA (US)

(73) Assignee: Hewlett-Packard Development Company, L.P., Spring, TX (US)

(21) Appl. No.: 17/642,728

(22) PCT Filed: Apr. 3, 2020
(86) PCT No.: PCT/US2020/026500

§ 371 Date: Mar. 14, 2022

(51) Int. Cl. C09D 175/04; C09D 11/322; C09D 11/54; D06P 5/30

(52) U.S. Cl. CPC C09D 175/04; C09D 11/322; C09D 11/54; D06P 5/30

(57) ABSTRACT

The present disclosure sets forth ink compositions having a biodegradable polyurethane binder that can be used for textile printing. In one example, an ink composition can include water, an organic co-solvent, a colorant, and a biodegradable polyurethane binder. The biodegradable polyurethane binder can include prepolymer segments including polymerized monomers of a diisocyanate and a diol. The diol can include to terminal 6-hydroxyhexanoate groups linked by an organic linking group. Chain extenders can connect the prepolymer segments. The chain extenders can include a polymerized diamine.

### BACKGROUND

Inkjet printing has become a popular way of recording images on various media. Some of the reasons include low printer noise, variable content recording, capability of high-speed recording, and multi-color recording. These features can be obtained at a relatively low price to consumers. As the popularity of inkjet printing increases, the types of use also increase providing demand for new ink compositions. In one example, textile printing can have various applications including the creation of signs, banners, artwork, apparel, wall coverings, window coverings, upholstery, pillows, blankets, flags, tote bags, clothing, etc. However, the permanence of printed ink on textiles can be an issue.

### BRIEF DESCRIPTION OF DRAWINGS

FIG. 1 is a schematic illustration of a reaction for forming a diol in accordance with the present disclosure;

FIG. 2 schematically depicts an example textile printing system in accordance with the present disclosure;

FIG. 3 schematically depicts another example textile printing system in accordance with the present disclosure; and

FIG. 4 provides a flow diagram for an example method of textile printing in accordance with the present disclosure.

### DETAILED DESCRIPTION

The present disclosure describes ink compositions that include biodegradable polyurethane binders. In one example, an ink composition includes water, an organic co-solvent, a colorant, and a biodegradable polyurethane binder. The biodegradable polyurethane binder includes prepolymer segments including polymerized monomers of a diisocyanate and a diol. The diol includes two terminal 6-hydroxyhexanoate groups linked by an organic linking group. Chain extenders connect the prepolymer segments. The chain extenders include a polymerized diamine. In some examples, the polymerized diamine can include a polymerized sulfonate-containing diamine and a polymerized non-ionic diamine. In further examples, the diol can have the following structure:

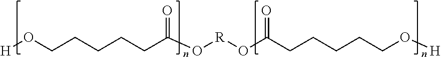

where R is a straight or branched alkyl chain having from 2 to 20 carbons and n is an integer from 1 to 20. In certain examples, the diol can have a weight average molecular weight from 300 g/mol to 3,000 g/mol. In another example, the diol can have a weight average molecular weight from 1000 g/mol to 3000 g/mol, and/or can include an excess of isocyanate groups from 1.25 wt % to 4 wt % based on a total weight of the biodegradable polyurethane binder. The diisocyanate and the diol can alternatively be included at a NCO:OH molar ratio from 1.01:1 to 3:1, and/or the biodegradable polyurethane binder has a D50 particle size from 50 nm to 350 nm. In other examples, the diisocyanate can include 2,2,4-trimethylhexane-1,6-diisocyanate (TMDI); 2,4,4-trimethylhexane-1,6-diisocyanate (TMDI); isophorone diisocyanate (IPDI); 1,3-bis(isocyanatomethyl)cyclohexane (H6XDI); hexamethylene diisocyanate (HDI); methylene diphenyl diisocyanate (MDI); 4,4′-methylene dicyclohexyl diisocyanate (H12MDI); or a combination thereof. In certain examples, the diisocyanate and the diol can be included at a NCO:OH molar ratio from 1.01:1 to 3:1. In further examples, the biodegradable polyurethane binder can have a D50 particle size from 50 nm to 350 nm. In still further examples, the polyurethane binder can have an acid number from 6 mg KOH/g to 30 mg KOH/g, in one example.

The present disclosure also describes textile printing systems. In one example, a textile printing system includes a fabric substrate and an inkjet printhead in fluid communication with a reservoir containing an ink composition to eject the ink composition. The ink composition includes water, an organic co-solvent, a colorant, and a biodegradable polyurethane binder. The biodegradable polyurethane binder includes prepolymer segments including polymerized monomers of a diisocyanate and a diol. The diol includes two terminal 6-hydroxyhexanoate groups linked by an organic linking group. Chain extenders connect the prepolymer segments. The chain extenders include a polymerized diamine. In certain examples, the fabric substrate can include cotton, polyester, silk, nylon, or a blend thereof. In further examples, the polymerized diamine can include a polymerized sulfonate-containing diamine and a polymerized non-ionic diamine.

The present disclosure also describes methods of textile printing. In one example, a method of textile printing includes jetting an ink composition onto a fabric substrate. The ink composition includes water, an organic co-solvent, a colorant, and a biodegradable polyurethane binder. The biodegradable polyurethane binder includes prepolymer segments including polymerized monomers of a diisocyanate and a diol. The diol includes two terminal 6-hydroxyhexanoate groups linked by an organic linking group. Chain extenders connect the prepolymer segments. The chain extenders include a polymerized diamine. In some examples, the method can also include applying a crosslinker composition onto the fabric substrate before jetting the ink composition. In further examples, the fabric substrate can include cotton, polyester, silk, nylon, or a blend thereof. In still further examples, the polymerized diamine can include a polymerized sulfonate-containing diamine and a polymerized non-ionic diamine.

It is noted that when discussing the ink compositions, textile printing systems, or the methods of textile printing herein, these discussions can be considered applicable to one another whether or not they are explicitly discussed in the context of that example. Thus, for example, when discussing an organic co-solvent related to the ink composition, such disclosure is also relevant to and directly supported in the context of the methods of textile printing, and vice versa. It is also understood that terms used herein will take on their ordinary meaning in the relevant technical field unless specified otherwise. In some instances, there are terms defined more specifically throughout the specification or included at the end of the present specification, and thus, these terms have a meaning as described herein.

### Ink Compositions

The ink compositions described herein can be particularly useful for textile printing. Many types of polymeric binders do not provide good durability when used in ink for printing on textiles. On the other hand, some polymeric binders may provide good durability but may not be jettable using inkjet printing architecture. For example, some polymeric binders can form particles or agglomerates that are too large to jet through an inkjet nozzle, and the polymeric binders can increase the viscosity of the ink and make the ink difficult to jet. Therefore, it can be difficult to formulate ink with polymeric binders that can provide good durability on textile media while also having good jettability. The ink compositions described herein include a polyurethane binder that can provide good durability when the ink compositions are printed on textile media, and the ink compositions can also have good jettability properties. The polyurethane binder can be crosslinkable. In some examples, the ink compositions can be printed in conjunction with a crosslinker composition that can crosslink the polyurethane binder. This can further increase the durability of the printed ink. In certain examples, the ink compositions described herein can be used in direct-to-garment (DTG) and direct-to-fabric (DTF) printing processes.

The polyurethane binders described herein can also be biodegradable. In particular, the polyurethane can be formed using a diol that is derived from caprolactone. These diols form segments in the polyurethane which can be cleaved by certain bacteria. Thus, the entire polyurethane polymer can be broken down by biodegrading the diol segments. The characteristic of biodegradability makes the inks more environmentally friendly. This characteristic can also make the ink easier to remove from a substrate in situations where the substrate is to be recycled or other circumstances in which de-inking is desired.

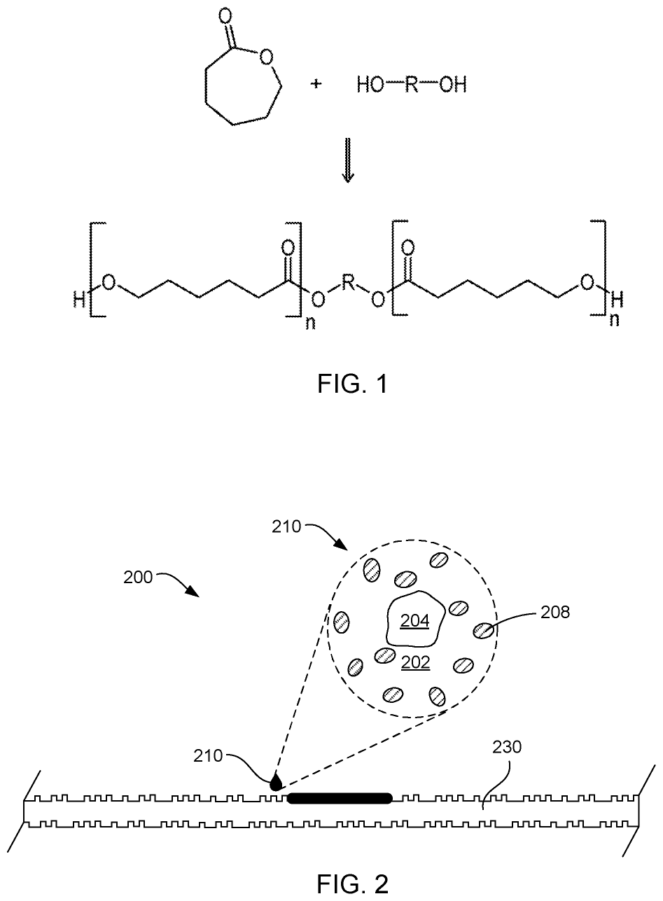

The polyurethane binders described herein can be made up of certain polymerized monomers. As mentioned above, these monomers can include a specific type of diol that is derived from caprolactone. The diols derived from caprolactone can be made, in some examples, by reacting a small molecule organic diol with caprolactone. The caprolactone can undergo a ring-opening reaction that results in caprolactone molecules converting to a linear shaped group that replaces a hydrogen atom on the hydroxyl groups of the small molecule organic diol. An example of this reaction is shown in FIG. 1. Additional caprolactone molecules can also react in a polymerization reaction to lengthen this molecule. The resulting product is a diol that includes two terminal 6-hydroxyhexanoate groups. The terminal groups are linked together by an organic linking group that includes the “R” group of the original small molecule diol, as shown in FIG. 1, in addition to any additional groups formed by polymerization of caprolactone molecules (e.g., a polycaprolactone chain).

The diols described above can be polymerized together with a diisocyanate or a combination of multiple different diisocyanates to from pre-polymer segments. The prepolymer segments can be connected by chain extenders, such as diamine chain extenders. Thus, the polymerized monomers that make up the polyurethane binder can include the diol, diisocyanates, and chain extenders. In some examples, other polymerized monomers can be included in addition to these. As used herein, “polymerized” is used with respect to monomers or segments of polymers to describe the monomers or segments of polymers in their polymerized state, e.g., after the monomers have bonded together to form a polymer chain. The names of monomers in their original state may be used even though it is understood that the monomers change in certain ways during polymerizing. For example, “polymerized diisocyanate and diol” can refer to a polymer chain formed by polymerizing a diisocyanate and a diol, even though the diisocyanate and diol do not actually exist as separate molecules in the polymer. In the case of polymerized diisocyanates and diols, a hydrogen atom of the hydroxyl group of the diol is replaced by a bond between the oxygen atom of the hydroxyl group and the carbon atom of the isocyanate group of the diisocyanate. Thus, the diol is no longer a diol, but has become a portion of a polymer chain. However, “polymerized diol” may still be used to refer to this portion of the polymer chain for the sake of convenience. The portions of the polymer chain formed from diisocyanates or diols can also be referred to as “diisocyanate units” and “diol units” for convenience. Similarly, pre-polymer segments can be described as being polymerized because the pre-polymer segments can react with chain extenders to form longer polymer chains. After formation of the longer polymer chain, the pre-polymer segment and the chain extender compounds no longer exist as independent molecules. However, these can be referred to as “polymerized pre-polymer segments” and “polymerized chain extenders” for convenience. Similarly, the chain extenders can be monomers that polymerize to form portions of the polyurethane chain. The term “chain extender” is used herein to refer to these monomers in both their polymerized state and prior to polymerization. In certain examples, the chain extenders can be diamine small molecules, which can polymerize with the other monomers to form the polyurethane chain. Thus, the “chain extenders” can refer to small molecule diamines before reacting with the other monomers, or to the polymerized diamines after reacting with the other monomers. The term “polymerized diamine” can refer to a portion of the polyurethane chain formed by reacting a small molecule diamine with the other monomers of the polymer chain. In a specific example, the polymerized diamines can be the portions of the polyurethane chain connecting prepolymer segments, which are formed by reacting small molecule diamines with prepolymer segments.

In a more specific example, the polyurethane binder can be formed by the following process. A pre-polymer segment can be formed by the reaction of a diisocyanate with a diol. The diol can include two terminal 6-hydroxyhexanoate groups as explained above. In this reaction, the isocyanate groups of the diisocyanate can react with hydroxyl groups of the diol to link the monomers together. More specifically, a hydrogen atom from a hydroxyl group of the diol is replaced by a bond between the oxygen atom of the hydroxyl group and the carbon atom of an isocyanate group of the diisocyanate. This results in a “urethane linkage” joining together the diisocyanate and the diol. Thus, the pre-polymer segment can include alternating diisocyanate and diol units. In some examples, these monomers can be mixed together simultaneously, and this can result in random polymerization. Therefore, in examples where multiple types of diisocyanate are included in the polymerization, or in examples where more than one diol compound are included, these monomers an be randomly distributed so long as the diol units alternate with the diisocyanate units. In some examples, an excess of the diisocyanate can be added to this reaction so that the product of the reaction can be pre-polymer segments that terminate in diisocyanate units at either end. Thus, the pre-polymer segments can have an unreacted isocyanate group at both ends that are available to react with additional monomers.

After forming the pre-polymer segments, a chain extender can be added. As mentioned above, the chain extender can include a diamine chain-extender. Diamines can include two amine groups that can react with isocyanate groups on the pre-polymer segments. In some cases, the amine groups can be —NH₂ groups or —NH— groups. Thus, a single diamine molecule can react with isocyanate groups on two different pre-polymer segments to link the pre-polymer segments together. In certain examples, the diamine chain extender can be a mixture of a sulfonate-containing diamine and a nonionic diamine. The sulfonate group of the sulfonate-containing diamine can help make the polyurethane polymer more water-dispersible.

In some examples, the diisocyanate, diols, and chain extenders described above can react in the presence of an organic solvent. After the polyurethane chain is complete, water can be added, and the organic solvent can be removed to form an aqueous dispersion of the polyurethane binder. In further examples, an excess of diisocyanate can be used when forming the polyurethane chains so that some unreacted isocyanate groups remain in the polyurethane binder dispersion. In certain examples, the polyurethane binder dispersion can have a D50 particle size from 50 nm to 350 nm. In other examples, the D50 particles size can be from 75 nm to 300 nm or from 150 nm to 250 nm.

In certain examples, the diisocyanate polymerized in the pre-polymer segment can be selected from the following diisocyanates:

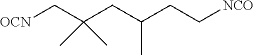

(2,2,4-trimethylhexane-1,6-diisocyanate (TMDI)),

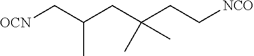

(2,4,4-trimethylhexane-1,6-diisocyanate (TMDI)),

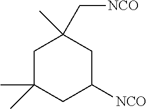

(isophorone diisocyanate (IPDI)),

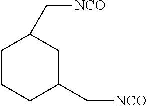

(1,3-bis(isocyanatomethyl)cyclohexane (H6XDI)),

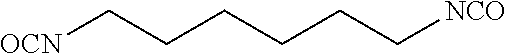

(hexamethylene diisocyanate (HDI)),

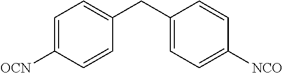

(methylene diphenyl diisocyanate (MDI)),

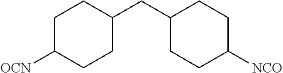

(4,4′-methylene dicyclohexyl diisocyanate (H12MDI)), or a combination thereof.

The diisocyanate can be reacted with a diol having two terminal 6-hydroxyhexanoate groups linked by an organic linking group as described above. In some examples, the diol can have the following structure:

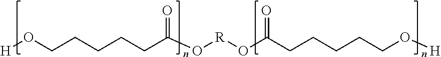

In this structure, R can be a straight or branched alkyl chain having from 2 to 20 carbons and n can be an integer from 1 to 20. As explained above, this diol can be made by polymerization caprolactone with a small molecule organic diol. The polymerization can be initiated by attaching ring-opened caprolactone molecules to the oxygens of the hydroxyl groups on the small molecule organic diol. Additional caprolactone molecules may also react and attach to form polycaprolactone chains. Thus, the final diol can terminate in 6-hydroxyhexanoate groups at both ends. The functional groups at the very ends of the molecule are hydroxyl groups. Therefore, the molecule is a diol and the hydroxyl groups can react with isocyanate groups when forming the polyurethane. The molecular weight of the diol can vary. In some examples, the diol can have a weight average molecular weight from 300 g/mol to 3,000 g/mol. In other examples, the molecular weight can be from 300 g/mol to 2,000 g/mol or from 500 g/mol to 2,000 g/mol. Non-limiting examples of commercially available diols of this type include PLACCEL® 205, PLACCEL® 210N, PLACCEL® 210AL, PLACCEL® 220EB, and PLACCEL® L212AL available from Daicel ChemTech, Inc. (U.S.A.).

In some examples, the diisocyanate and the diol can react together to form pre-polymer segments having isocyanate groups at one or both ends of the pre-polymer segments. In certain examples, the pre-polymer segments can be formed with a NCO:OH ratio from 1:011 to 3:1. In further examples, the NCO:OH molar ratio can be from 1.01:1 to 2:1 or from 1.03:1 to 1.5:1. As used herein, “NCO:OH ratio” or “NCO:OH molar ratio” refers to the mole ratio of NCO groups to OH groups in the monomers that react to form the pre-polymer segment.

The pre-polymer segments can be formed by polymerizing the diisocyanate and diol described above. In some examples, the polymerization can be accomplished by mixing the monomers in the presence of an organic solvent and an initiator. In certain examples, the initiator can be dibutyl tin dilaurate (DBTDL). After polymerizing the pre-polymer segments, the pre-polymer segments can be linked together by adding a chain extender. The chain extender can include two reactive groups that can react with isocyanate groups at the ends of the pre-polymer segments.

As mentioned above, in some examples the chain extender can include diamine chain extenders. In certain examples, a combination of a sulfonate-containing diamine and a nonionic diamine can be used. The sulfonate-containing diamine can have two amino groups that react with isocyanate groups at the ends of the pre-polymer segments. The sulfonate group can be an anionic group that can help make the polyurethane binder more water dispersible. In certain examples, the sulfonate-containing diamine can be 2-((2-Aminoethyl)amino)ethanesulfonate or a salt thereof. In one example, the sulfonate-containing diamine can include A-95™ available from Evonik (Germany). Nonionic diamine chain extenders can also include two amino groups that are reactive with the isocyanate groups. However, the nonionic diamine does not include a sulfonate group. Non-limiting examples of nonionic diamine chain extenders include 1,3-propanediamine, hydrazine, 1,2-ethanediamine, 1,4-butanediamine, 1,5-pentanediamine, 1,6-hexanediamine, 1,7-heptanediamine, 1,8-octanediamine, 1,9-nonanediamine, 1,10-decanediamine, 2,2,4-trimethyl-1,6-hexanediamine, diethylenetriamine, 1,4-cyclohexanediamine, 4-methyl-1,3-cyclohexanediamine, 5-amino-1,3,3-trimethyl-cyclohexanamine cyclohexanemethanamine, 4,4′-methylenebis[2-methyl-4,4′-methylenebis-cyclohexanamine, and others.

In further examples, the biodegradable polyurethane binder can have an acid number that is greater than 0, for example, but in some more specific examples, the acid number can be from 6 mg KOH/g to 30 mg KOH/g. In other examples, the polyurethane binder can have an acid number from 6 mg KOH/g to 20 mg KOH/g or from 6 mg KOH/g to 15 mg KOH/g. In certain examples, the acid number can be adjusted by changing the amounts of sulfonated diamine vs. nonionic diamine used as chain extenders.

The polyurethane binder can be formed into a dispersion having polyurethane particles dispersed in an aqueous vehicle. As mentioned above, the polyurethane binder can be polymerized by mixing monomers in an organic solvent. After the polymerization, water can be added and/or organic solvent can be removed to form an aqueous dispersion of the polyurethane binder. In some examples, the polyurethane binder dispersion can have a D50 particle size from 50 nm to 350 nm. In other examples, the D50 particle size can be from 75 nm to 300 nm or from 150 nm to 250 nm.

The polyurethane binder dispersion can be included in the ink composition in any amount that does not interfere with the jettability of the ink composition. In some examples, the polyurethane binder can be present in an amount from 0.1 wt % to 30 wt % with respect to the total weight of the ink composition. In further examples, the polyurethane binder can be present in an amount from 0.1 wt % to 15 wt %, or from 0.5 wt % to 10 wt %, or form 0.6 wt % to 5 wt %, with respect to the total weight of the ink composition.

As mentioned above, the ink compositions can include water, an organic co-solvent, and a colorant in addition to the polyurethane binder. In some examples, the colorant can include a pigment. In some examples, pigment can be included in an amount from 0.5 wt % to 15 wt %, or from 1 wt % to 10 wt %, or from 5 wt % to 10 wt %, based on the total weight of the ink composition.

The pigment can be any of a number of pigments of any of a number of colors, or can be black or white, for example. More specifically, colors can include cyan, magenta, yellow, red, blue, violet, red, orange, green, etc. In one example, the ink composition can be a black ink with a carbon black pigment. In another example, the ink composition can be a cyan or green ink with a copper phthalocyanine pigment, e.g., Pigment Blue 15:0, Pigment Blue 15:1; Pigment Blue 15:3, Pigment Blue 15:4, Pigment Green 7, Pigment Green 36, etc. In another example, the ink composition can be a magenta ink with a quinacridone pigment or a co-crystal of quinacridone pigments. Example quinacridone pigments that can be utilized can include PR122, PR192, PR202, PR206, PR207, PR209, P048, P049, PV19, PV42, or the like. These pigments tend to be magenta, red, orange, violet, or other similar colors. In one example, the quinacridone pigment can be PR122, PR202, PV19, or a combination thereof. In another example, the ink composition can be a yellow ink with an azo pigment, e.g., PY74 and PY155. Other examples of pigments include the following, which are available from BASF Corp. (Germany): PALIOGEN® Orange, HELIOGEN® Blue L 6901F, HELIOGEN® Blue NBD 7010, HELIOGEN® Blue K 7090, HELIOGEN® Blue L 7101F, PALIOGEN® Blue L 6470, HELIOGEN® Green K 8683, HELIOGEN® Green L 9140, CHROMOPHTAL® Yellow 3G, CHROMOPHTAL® Yellow GR, CHROMOPHTAL® Yellow 8G, IGRAZIN® Yellow SGT, and IGRALITE® Rubine 4BL. The following pigments are available from Degussa Corp. (Germany): Color Black FWI, Color Black FW2, Color Black FW2V, Color Black 18, Color Black, FW200, Color Black 5150, Color Black S160, and Color Black 5170. The following black pigments are available from Cabot Corp. (U.S.A.): REGAL® 400R, REGAL® 330R, REGAL® 660R, MOGUL® L, BLACK PEARLS® L, MONARCH® 1400, MONARCH® 1300, MONARCH® 1100, MONARCH® 1000, MONARCH® 900, MONARCH® 880, MONARCH® 800, and MONARCH® 700. The following pigments are available from Orion Engineered Carbons GMBH (Luxembourg): PRINTEX® U, PRINTEX® V, PRINTEX® 140U, PRINTEX® 140V, PRINTEX® 35, Color Black FW 200, Color Black FW 2, Color Black FW 2V, Color Black FW 1, Color Black FW 18, Color Black S 160, Color Black S 170, Special Black 6, Special Black 5, Special Black 4A, and Special Black 4. The following pigment is available from DuPont (U.S.A.): TI-PURE® R-101. The following pigments are available from Heubach (India): MONASTRAL® Magenta, MONASTRAL® Scarlet, MONASTRAL® Violet R, MONASTRAL® Red B, and MONASTRAL® Violet Maroon B. The following pigments are available from Clariant (Switzerland): DALAMAR® Yellow YT-858-D, Permanent Yellow GR, Permanent Yellow G, Permanent Yellow DHG, Permanent Yellow NCG-71, Permanent Yellow GG, Hansa Yellow RA, Hansa Brilliant Yellow 5GX-02, Hansa Yellow-X, NOVOPERM® Yellow HR, NOVOPERM® Yellow FGL, Hansa Brilliant Yellow 10GX, Permanent Yellow G3R-01, HOSTAPERM® Yellow H4G, HOSTAPERM® Yellow H3G, HOSTAPERM® Orange GR, HOSTAPERM® Scarlet GO, and Permanent Rubine F6B. The following pigments are available from Sun Chemical (U.S.A.): QUINDO® Magenta, INDOFAST® Brilliant Scarlet, QUINDO® Red R6700, QUINDO® Red R6713, INDOFAST® Violet, L74-1357 Yellow, L75-1331 Yellow, L75-2577 Yellow, and LHD9303 Black. The following pigments are available from Birla Carbon (India): RAVEN® 7000, RAVEN® 5750, RAVEN® 5250, RAVEN® 5000 Ultra® II, RAVEN® 2000, RAVEN® 1500, RAVEN® 1250, RAVEN® 1200, RAVEN® 1190 Ultra®. RAVEN® 1170, RAVEN® 1255, RAVEN® 1080, and RAVEN® 1060. The following pigments are available from Mitsubishi Chemical Corp. (Japan): No. 25, No. 33, No. 40, No. 47, No. 52, No. 900, No. 2300, MCF-88, MA600, MA7, MA8, and MA100. The colorant may be a white pigment, such as titanium dioxide, or other inorganic pigments such as zinc oxide and iron oxide.

Specific other examples of a cyan color pigment may include C.I. Pigment Blue-1, -2, -3, -15, -15:1, -15:2, -15:3, -15:4, -16, -22, and -60; magenta color pigment may include C.I. Pigment Red-5, -7, -12, -48, -48:1, -57, -112, -122, -123, -146, -168, -177, -184, -202, and C.I. Pigment Violet-19; yellow pigment may include C.I. Pigment Yellow-1, -2, -3, -12, -13, -14, -16, -17, -73, -74, -75, -83, -93, -95, -97, -98, -114, -128, -129, -138, -151, -154, and -180. Black pigment may include carbon black pigment or organic black pigment such as aniline black, e.g., C.I. Pigment Black 1. While several examples have been given herein, it is to be understood that any other pigment can be used that is useful in color modification, or dye may even be used in addition to the pigment.

Furthermore, pigments and dispersants are described separately herein, but there are pigments that are commercially available which include both the pigment and a dispersant suitable for ink composition formulation. Specific examples of pigment dispersions that can be used, which include both pigment solids and dispersant are provided by example, as follows: HPC-K048 carbon black dispersion from DIC Corporation (Japan), HSKBPG-11-CF carbon black dispersion from Dom Pedro (USA), HPC-0070 cyan pigment dispersion from DIC, CABOJET® 250C cyan pigment dispersion from Cabot Corporation (USA), 17-SE-126 cyan pigment dispersion from Dom Pedro, HPF-M046 magenta pigment dispersion from DIC, CABOJET® 265M magenta pigment dispersion from Cabot, HPJ-Y001 yellow pigment dispersion from DIC, 16-SE-96 yellow pigment dispersion from Dom Pedro, or EMACOL™ SF Yellow AE2060F yellow pigment dispersion from Sanyo (Japan).

Thus, the pigment(s) can be dispersed by a dispersant that is adsorbed or ionically attracted to a surface of the pigment, or can be covalently attached to a surface of the pigment as a self-dispersed pigment. In one example, the dispersant can be an acrylic dispersant, such as a styrene (meth)acrylate dispersant, or other dispersant suitable for keeping the pigment suspended in the liquid vehicle. In one example, the styrene (meth)acrylate dispersant can be used, as it can promote π-stacking between the aromatic ring of the dispersant and various types of pigments. In one example, the styrene (meth)acrylate dispersant can have a weight average molecular weight from 4,000 Mw to 30,000 Mw. In another example, the styrene-acrylic dispersant can have a weight average molecular weight of 8,000 Mw to 28,000 Mw, from 12,000 Mw to 25,000 Mw, from 15,000 Mw to 25,000 Mw, from 15,000 Mw to 20,000 Mw, or 17,000 Mw. Regarding the acid number, the styrene (meth)acrylate dispersant can have an acid number from 100 mg KOH/g to 350 mg KOH/g, from 120 mg KOH/g to 350 mg KOH/g, from 150 mg KOH/g to 300 mg KOH/g, from 180 mg KOH/g to 250 mg KOH/g, or 201 mg KOH/g to 220 mg KOH/g, for example. Example commercially available styrene-acrylic dispersants can include JONCRYL® 671, JONCRYL® 71, JONCRYL® 96, JONCRYL® 680, JONCRYL® 683, JONCRYL® 678, JONCRYL® 690, JONCRYL® 296, JONCRYL® 671, JONCRYL® 696 or JONCRYL® ECO 675 (all available from BASF Corp., Germany).

The term “(meth)acrylic” refers to monomers, copolymerized monomers, etc., that can either be acrylate or methacrylate (or a combination of both), or acrylic acid or methacrylic acid (or a combination of both), as the acid or salt/ester form can be a function of pH. Furthermore, even if the monomer used to form the polymer was in the form of a (meth)acrylic acid during preparation, pH modifications during preparation or subsequently when added to an ink composition can impact the nature of the moiety as well (acid form vs. salt or ester form). Thus, a monomer or a moiety of a polymer described as (meth)acrylic should not be read so rigidly as to not consider relative pH levels, ester chemistry, and other organic chemistry concepts.

The ink compositions of the present disclosure can be formulated to include a liquid vehicle, which can include the water content, e.g., 30 wt % to 99 wt %, 50 wt % to 95 wt %, 60 wt % to 90 wt % or from 70 wt % to 90 wt %, as well as organic co-solvent, e.g., from 1 wt % to 40 wt %, from 4 wt % to 30 wt %, from 4 wt % to 20 wt %, or from 5 wt % to 15 wt %. Other liquid vehicle components can also be included, such as surfactant, antibacterial agent, other colorant, etc. However, as part of the ink composition used in the systems and methods described herein, the pigment, dispersant, and polyurethane binder can be included or carried by the liquid vehicle components. Suitable pH ranges for the ink composition can be from pH 6 to pH 10, from pH 7 to pH 10, from pH 7.5 to pH 10, from pH 8 to pH 10, 6 to pH 9, from pH 7 to pH 9, from pH 7.5 to pH 9, etc.

In further detail regarding the liquid vehicle, the organic co-solvent(s) can be present and can include any co-solvent or combination of co-solvents that is compatible with the pigment, dispersant, and polyurethane binder. Examples of suitable classes of co-solvents include polar solvents, such as alcohols, amides, esters, ketones, lactones, and ethers. In additional detail, solvents that can be used can include aliphatic alcohols, aromatic alcohols, diols, glycol ethers, polyglycol ethers, caprolactams, formamides, acetamides, and long chain alcohols. Examples of such compounds include aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. More specific examples of organic solvents can include 2-pyrrolidone, 2-ethyl-2-(hydroxymethyl)-1, 3-propane diol (EPHD), glycerol, dimethyl sulfoxide, sulfolane, glycol ethers, alkyldiols such as 1,2-hexanediol, and/or ethoxylated glycerols such as LEG-1, etc.

The liquid vehicle can also include surfactant and/or emulsifier. The surfactant can be water soluble and may include alkyl polyethylene oxides, alkyl phenyl polyethylene oxides, polyethylene oxide (PEO) block copolymers, acetylenic PEO, PEO esters, PEO amines, PEO amides, dimethicone copolyols, ethoxylated surfactants, alcohol ethoxylated surfactants, fluorosurfactants, and mixtures thereof. In some examples, the surfactant can include a nonionic surfactant, such as a SURFYNOL® surfactant, e.g., SURFYNOL® 440 (from Evonik, Germany), or a TERGITOL™ surfactant, e.g., TERGITOL™ TMN-6 (from Dow Chemical, USA). In another example, the surfactant can include an anionic surfactant, such as a phosphate ester of a C10 to C20 alcohol or a polyethylene glycol (3) oleyl mono/di phosphate, e.g., CRODAFOS® N3A (from Croda International PLC, United Kingdom). The surfactant or combinations of surfactants, if present, can be included in the ink composition at from 0.01 wt % to 5 wt % and, in some examples, can be present at from 0.05 wt % to 3 wt % of the ink compositions.

Consistent with the formulations of the present disclosure, various other additives may be included to provide desired properties of the ink composition for specific applications. Examples of these additives are those added to inhibit the growth of harmful microorganisms. These additives may be biocides, fungicides, and other microbial agents, which are routinely used in ink formulations. Examples of suitable microbial agents include, but are not limited to, ACTICIDE®, e.g., ACTICIDE® B20 (Thor Specialties Inc., U.S.A), NUOSEPT™ (Nudex, Inc., U.S.A.), UCARCIDE™ (Union carbide Corp., U.S.A.), VANCIDE® (R.T. Vanderbilt Co., U.S.A.), PROXEL™ (ICI America, U.S.A.), and combinations thereof. Sequestering agents, such as EDTA (ethylene diamine tetra acetic acid) or trisodium salt of methylglycinediacetic acid, may be included to eliminate the deleterious effects of heavy metal impurities, and buffer solutions may be used to control the pH of the ink. Viscosity modifiers and buffers may also be present, as well as other additives to modify properties of the ink as desired.

### Textile Printing Systems

The ink compositions described herein can be used in textile printing systems. FIG. 2 shows an example textile printing system 200 which includes a fabric substrate 230 and an ink composition 210. The ink composition includes water, an organic co-solvent (shown collectively as liquid vehicle 202), pigment 204 as a colorant, and particles of the polyurethane binder 208 described above. The ink composition can also include any of the other ingredients described above. As explained above, the polyurethane binder can give the ink composition good durability when printed. The ink composition can be printed on various types of fabrics, such as cotton, nylon, silk, polyester, cotton/polyester blend, etc. The durability of the printed ink on the fabric can be tested by washing, for example by performing a washfastness test that includes five (5) standard washing machine cycles using warm water and a standard clothing detergent. Acceptable optical density retention and other color properties of the printed inks can be the result. Additionally, the ink compositions can also exhibit good stability over time as well as good thermal inkjet printhead performance such as high drop weight, high drop velocity, and good kogation.

The term “washfastness” can be defined as the optical density (OD) or delta E (ΔE) that is retained after five (5) standard washing machine cycles using warm water and a standard clothing detergent (e.g., TIDE® available from Proctor and Gamble, Cincinnati, Ohio, USA). By measuring OD and/or L*a*b* both before and after washing, ΔOD and ΔE value can be determined, which is a quantitative way of expressing the difference between the OD and/or L*a*b*prior to and after undergoing the washing cycles. Thus, the lower the ΔOD and ΔE values, the better. In further detail, ΔE is a single number that represents the “distance” between two colors, which in accordance with the present disclosure, is the color (or black) prior to washing and the modified color (or modified black) after washing.

Colors, for example, can be expressed as CIELAB values. It is noted that color differences may not be symmetrical going in both directions (pre-washing to post washing vs. post-washing to pre-washing). Using the CIE 1976 definition, the color difference can be measured and the ΔE value calculated based on subtracting the pre-washing color values of L*, a*, and b* from the post-washing color values of L*, a*, and b*. Those values can then be squared, and then a square root of the sum can be determined to arrive at the ΔE value. The 1976 standard can be referred to herein as “ΔE CIE.” The CIE definition was modified in 1994 to address some perceptual non-uniformities, retaining the L*a*b* color space, but modifying to define the L*a*b* color space with differences in lightness (L*), chroma (C*), and hue (h*) calculated from L*a*b* coordinates. This can be referred to herein as the “ΔE 1994.” Then in 2000, the CIEDE standard was established to further resolve the perceptual non-uniformities by adding five corrections, namely i) hue rotation (R_{T}) to deal with the blue region at hue angles of about 275°), ii) compensation for neutral colors or the primed values in the L*C*h differences, iii) compensation for lightness (S_{L}), iv) compensation for chroma (S_{C}), and v) compensation for hue (SH). The 2000 modification can be referred to herein as “ΔE 2000.” In accordance with examples of the present disclosure, ΔE value can be determined using the CIE definition established in 1976, 1994, and 2000 to demonstrate washfastness. Further, a difference measurement has also been established, based on an L*C*h model was defined and called CMC l:c. This metric has two parameters: lightness (l) and chroma (c), allowing users to weigh the difference based on the ratio of l:c that is deemed appropriate for the application. Commonly used values include 2:1 for acceptability and 1:1 for threshold of imperceptibility. This difference metric is also reported in various examples of the present disclosure. This can be referred to as “ΔE CMC 2:1” or “ΔE CMC 1:1,” depending on the l and c values selected for measurement.

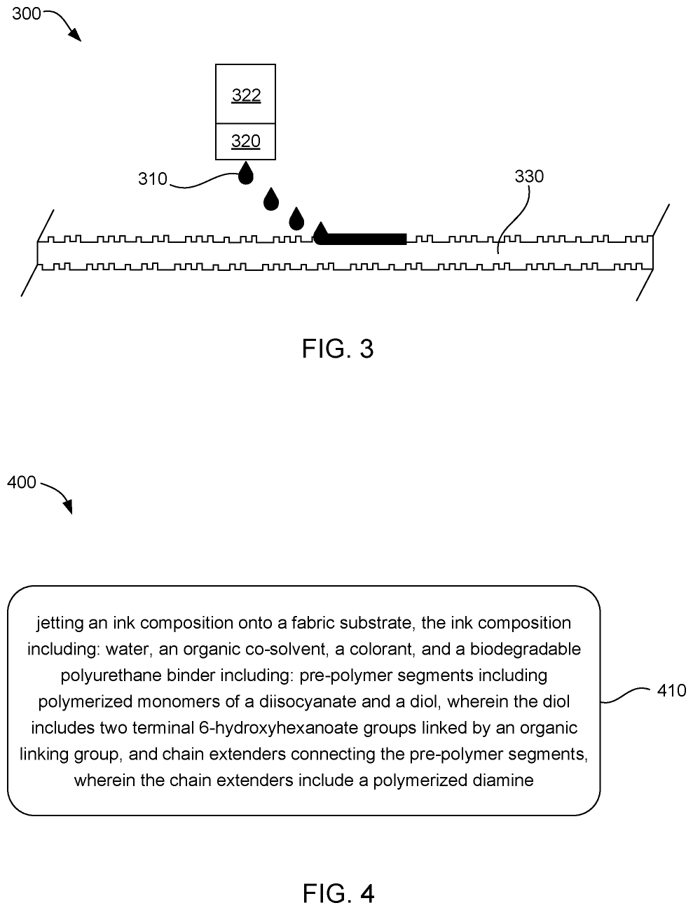

As shown in FIG. 3, a textile printing system 300 can print the ink compositions 310 on fabric substrates 330. For example, the ink compositions can be printed from an inkjet printhead 320 which includes an ejector, such as a thermal inkjet ejector, for example. The printhead is in fluid communication with a reservoir 322 that contains the ink composition.

These ink compositions can be suitable for printing on many types of textiles, but can be particularly acceptable on treated or untreated natural fabric textile substrates, e.g., wool, cotton, silk, linen, jute, flax, hemp, rayon fibers, thermoplastic aliphatic polymeric fibers derived from renewable resources (e.g. cornstarch, tapioca products, sugarcanes), etc. Treated fabrics can include a coating, for example, such as a coating including a cationic component such as calcium salt, magnesium salt, cationic polymer, etc. These types of substrates can provide acceptable optical density (OD) and/or washfastness properties.

In further detail regarding the fabric substrates, the fabric can include a substrate, and in some examples can be treated, such as with a coating that includes a calcium salt, a magnesium salt, a cationic polymer, or a combination of a calcium or magnesium salt and cationic polymer. Fabric substrates can include substrates that have fibers that may be natural and/or synthetic. The fabric substrate can include, for example, a textile, a cloth, a fabric material, fabric clothing, or other fabric product suitable for applying ink, and the fabric substrate can have any of a number of fabric structures. The term “fabric structure” is intended to include structures that can have warp and weft, and/or can be woven, non-woven, knitted, tufted, crocheted, knotted, and pressured, for example. The terms “warp” and “weft” have their ordinary meaning in the textile arts, as used herein, e.g., warp refers to lengthwise or longitudinal yarns on a loom, while weft refers to crosswise or transverse yarns on a loom.

It is notable that the term “fabric substrate” does not include materials referred to as any kind of paper (even though paper can include multiple types of natural and synthetic fibers or mixtures of both types of fibers). Fabric substrates can include textiles in filament form, textiles in the form of fabric material, or textiles in the form of fabric that has been crafted into a finished article (e.g. clothing, blankets, tablecloths, napkins, towels, bedding material, curtains, carpet, handbags, shoes, banners, signs, flags, etc.). In some examples, the fabric substrate can have a woven, knitted, non-woven, or tufted fabric structure. In one example, the fabric substrate can be a woven fabric where warp yarns and weft yarns can be mutually positioned at an angle of about 90°. This woven fabric can include but is not limited to, fabric with a plain weave structure, fabric with a twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are one or both bonded together and interlocked together by a chemical treatment process (e.g., a solvent treatment), a mechanical treatment process (e.g., embossing), a thermal treatment process, or a combination of two or more of these processes.

Regardless of the structure, in one example, the fabric substrate can include natural fibers, synthetic fibers, or a combination thereof. Examples of natural fibers can include, but are not limited to, wool, cotton, silk, linen, jute, flax, hemp, rayon fibers, thermoplastic aliphatic polymeric fibers derived from renewable resources (e.g. cornstarch, tapioca products, sugarcanes), or a combination thereof. In another example, the fabric substrate can include synthetic fibers. Examples of synthetic fibers can include polymeric fibers such as, polyvinyl chloride (PVC) fibers, PVC-free fibers made of polyester, polyamide, polyimide, polyacrylic, polypropylene, polyethylene, polyurethane, polystyrene, polyaramid (e.g., KEVLAR®) polytetrafluoroethylene (TEFLON®) (both trademarks of E. I. du Pont de Nemours Company, Delaware), fiberglass, polytrimethylene, polycarbonate, polyethylene terephthalate, polyester terephthalate, polybutylene terephthalate, or a combination thereof. In some examples, the synthetic fiber can be a modified fiber from the above-listed polymers. The term “modified fiber” refers to one or both of the polymeric fiber and the fabric as a whole having undergone a chemical or physical process such as, but not limited to, a copolymerization with monomers of other polymers, a chemical grafting reaction to contact a chemical functional group with one or both the polymeric fiber and a surface of the fabric, a plasma treatment, a solvent treatment, acid etching, or a biological treatment, an enzyme treatment, or antimicrobial treatment to prevent biological degradation. The term “PVC-free fibers” as used herein means that no polyvinyl chloride (PVC) polymer or vinyl chloride monomer units are in the fibers.

As previously mentioned, the fabric substrate can be a combination of fiber types, e.g. a combination of any natural fiber with another natural fiber, any natural fiber with a synthetic fiber, a synthetic fiber with another synthetic fiber, or mixtures of multiple types of natural fibers and/or synthetic fibers in any of the above combinations. In some examples, the fabric substrate can include natural fiber and synthetic fiber. The amount of the individual fiber types can vary. For example, the amount of the natural fiber can vary from 5 wt % to 95 wt % and the amount of synthetic fiber can range from 5 wt % to 95 wt %. In yet another example, the amount of the natural fiber can vary from 10 wt % to 80 wt % and the synthetic fiber can be present from 20 wt % to 90 wt %. In other examples, the amount of the natural fiber can be 10 wt % to 90 wt % and the amount of synthetic fiber can also be 10 wt % to 90 wt %. Likewise, the ratio of natural fiber to synthetic fiber in the fabric substrate can vary. For example, the ratio of natural fiber to synthetic fiber can be 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa.

In one example, the fabric substrate can have a basis weight ranging from 10 gsm to 500 gsm. In another example, the fabric substrate can have a basis weight ranging from 50 gsm to 400 gsm. In other examples, the fabric substrate can have a basis weight ranging from 100 gsm to 300 gsm, from 75 gsm to 250 gsm, from 125 gsm to 300 gsm, or from 150 gsm to 350 gsm.

In addition, the fabric substrate can contain additives including, but not limited to, colorant (e.g., pigments, dyes, and tints), antistatic agents, brightening agents, nucleating agents, antioxidants, UV stabilizers, fillers, and lubricants, for example. Alternatively, the fabric substrate may be pre-treated in a solution containing the substances listed above before applying other treatments or coating layers.

### Methods of Textile Printing

The ink compositions described herein and the textile printing systems described herein can also be used in methods of textile printing. FIG. 4 shows a flowchart of one example method 400 of textile printing. The method includes: jetting 410 an ink composition onto a fabric substrate, the ink composition including: water, an organic co-solvent, a colorant, and a biodegradable polyurethane binder including: pre-polymer segments including polymerized monomers of a diisocyanate and a diol, wherein the diol includes two terminal 6-hydroxyhexanoate groups linked by an organic linking group, and chain extenders connecting the pre-polymer segments, wherein the chain extenders include a polymerized diamine.

In some examples, a crosslinker composition can be applied onto the fabric substrate before jetting the ink composition. In other examples, the crosslinker composition can be applied after or concurrently with the ink composition. The crosslinker composition can include a crosslinker that is reactive with the polyurethane binder to crosslink the polyurethane binder. This can increase the durability of the ink printed on the fabric substrate. In some examples, the crosslinker can include blocked isocyanates, polycarbodiimides or polymeric azetidinium salts. In certain examples, the crosslinker can be a polyimine based azetidinium salt such as POLYCUP™ 7360A from Solenis (USA), which has the following structure:

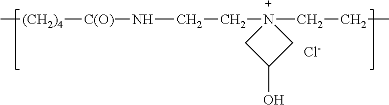

The crosslinker composition can also include a liquid vehicle with any of the liquid vehicle components described above with respect to the inks.

In some examples, a fixer composition may also be used in addition to the crosslinker composition, or instead of the crosslinker composition. As mentioned, there are also examples that do not use either a crosslinker composition or a fixer composition. Fixer compositions can include metal salts that can help fix pigments on the fabric substrate. Non-limiting examples of metal salt fixers can include salts of metal cations such as Ca²⁺, Cu²⁺, Ni²⁺, Mg²⁺, Zn²⁺Ba²⁺, Al³⁺, Fe³⁺ or Cr³⁺ with anions such as Cl⁻, I⁻, Br⁻, NO₃⁻ or RCOO⁻ (where R is H or any hydrocarbon chain). In some examples, fixer compositions can also include liquid vehicle components such as those described above with respect to the ink compositions.

In further examples, the ink compositions described herein can be cured after printing by heating the printed fabric to a curing temperature for a period of time. Therefore, in some examples the method of textile printing can include curing the ink composition after printing on the fabric substrate by heating the fabric substrate. In certain examples, the fabric substrate can be heated to a curing temperature from 50° C. to 180° C. In further examples, the curing temperature can be from 60° C. to 150° C. or from 70° C. to 130° C. The fabric substrate can be heated at this temperature for a curing time. In some examples, the curing time can be from 30 seconds to 30 minutes. In further examples, the curing time can be from 1 minute to 10 minutes, from 1 minute to 5 minutes, or from 1 minute to 3 minutes.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable based on experience and the associated description herein.

The term “acid value” or “acid number” refers to the mass of potassium hydroxide (KOH) in milligrams that can be used to neutralize one gram of substance (mg KOH/g), such as the polyurethane binders disclosed herein. This value can be determined, in one example, by dissolving or dispersing a known quantity of a material in organic solvent and then titrating with a solution of potassium hydroxide (KOH) of known concentration for measurement.

“D50” particle size is defined as the particle size at which about half of the particles are larger than the D50 particle size and about half of the other particles are smaller than the D50 particle size (by weight based on the particle content). As used herein, particle size with respect to the polyurethane binder particles can be based on volume of the particle size normalized to a spherical shape for diameter measurement, for example. Particle size can be collected using a Malvern ZETASIZER™ from Malvern Panalytical (United Kingdom), for example. Likewise, the “D95” is defined as the particle size at which about 5 wt % of the particles are larger than the D95 particle size and about 95 wt % of the remaining particles are smaller than the D95 particle size. Particle size information can also be determined and/or verified using a scanning electron microscope (SEM), or can be measured using a particle analyzer such as the MASTERS IZER™ 3000 available from Malvern Panalytical (United Kingdom), for example. The particle analyzer can measure particle size using laser diffraction. A laser beam can pass through a sample of particles and the angular variation in intensity of light scattered by the particles can be measured. Larger particles scatter light at smaller angles, while small particles scatter light at larger angles. The particle analyzer can then analyze the angular scattering data to calculate the size of the particles using the Mie theory of light scattering. The particle size can be reported as a volume equivalent sphere diameter.

As used herein, a plurality of items, structural elements, compositional elements, and/or materials may be presented in a common list for convenience. However, these lists should be construed as though the members of the list are individually identified as separate and unique members. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, and also to include all the individual numerical values or sub-ranges encompassed within that range as if the numerical values and sub-ranges are explicitly recited. For example, a weight ratio range of 1 wt % to 20 wt % should be interpreted to include the explicitly recited limits of 1 wt % and 20 wt %, and also to include individual weights such as 2 wt %, 11 wt %, 14 wt %, and sub-ranges such as 10 wt % to 20 wt %, 5 wt % to 15 wt %, etc.

### EXAMPLES

The following examples illustrate the technology of the present disclosure. However, it is to be understood that the following is merely illustrative of the methods and systems herein. Numerous modifications and alternative methods and systems may be devised without departing from the present disclosure. Thus, while the technology has been described above with particularity, the following provides further detail in connection with what are presently deemed to be the acceptable examples.

### Example 1—Polyurethane Binder Compositions

A series of eleven polyurethane binders were prepared using different combinations and amounts of monomers. All of the binders included isophorone diisocyanate (IPDI) as the diisocyanate. Four different diols were used in various binders. The diols included PLACCEL® 210N, PLACCEL® L212AL, PLACCEL® 220EB, and PLACCEL® 205 from Daicel ChemTech Inc. (U.S.A.). These diols are somewhat different but are formed by polymerizing a small molecule diol with a caprolactone. Two diamine chain extenders were included in the binders as well, namely A-95™, which is a sulfonate-containing diamine available from Evonik (Germany), and isophorone diamine (IPDA), which is a nonionic diamine. The various binders are identified as Binder ID 1-11 in Tables 1-5 hereinafter. The amounts of these monomers in weight percent are shown in Table 1. These amounts represent the amount of the respective monomers that were added during polymerization.

TABLE 1
Binder Identity and Monomer Content

| | | | | PLACCEL ® | PLACCEL ® |
|---|---|---|---|---|---|
| | A-95 ™ | IPDA | IPDI | Hydroxy- | Hydroxy- |
| | sulfonated | nonionic | diisocy- | hexanoate | hexanoate |
| Binder | diamine | diamine | anate | diol | diol |
| ID | (wt %) | (wt %) | (wt %) | (ID and Mw) | (wt %) |
| 1 | 6.426 | 8.889 | 44.372 | PLACCEL ® | 240.314 |
| 2 | 5.877 | 8.129 | 40.579 | 205 | 45.416 |
| 3 | 5.518 | 7.634 | 38.107 | 525 g/mol | 48.741 |
| 4 | 4.708 | 6.513 | 32.513 | PLACCEL ® | 56.265 |
| 5 | 4.165 | 5.761 | 28.761 | 210N | 61.312 |
| 6 | 3.830 | 5.297 | 26.445 | 1000 g/mol | 64.428 |
| 7 | 4.128 | 5.71 | 28.504 | PLACCEL ® | 61.659 |
| 8 | 3.612 | 4.996 | 24.936 | L212AL | 66.454 |
| 9 | 3.298 | 4.563 | 22.776 | 1250 g/mol | 69.363 |
| 10 | 3.013 | 4.168 | 20.806 | PLACCEL ® | 72.013 |
| 11 | 2.582 | 3.572 | 17.829 | 2000 g/mol | 76.017 |
| | | | | 220EB | |

Several properties were measured for the polyurethane binders. The measured properties are shown in Table 2. The particle size is the D50 particle size in nm. Particle size can be collected using a ZETASIZER™ or MASTERSIZER™ 3000, from Malvern Panalytical (United Kingdom), and/or can be determined verified using a scanning electron microscope (SEM). pH refers to the pH of the polyurethane binder dispersion and can be measured using an ACCUMET XL250 pH meter, from Fisher Scientific (USA). Acid number is the acid number or acid value of the polyurethane dispersion and the values provided are theoretical values that are calculated based on the ingredients used, but can likewise be measured (with similar results) by dissolving or dispersing a known quantity of a material in organic solvent and then titrating with a solution of potassium hydroxide (KOH) of known concentration for measurement. Excess NCO content can be calculated based on the ingredients used.

TABLE 2
Binder Properties

| | | D50 Particle | | | NCO |
|---|---|---|---|---|---|
| Binder | Solids | Size | | Acid Number | Excess |
| ID | (wt %) | (nm) | pH | (mg KOH/g) | (wt %) |
| 1 | 30.74 | 70.15 | 5.5 | 19.0 | 3.1 |
| 2 | Gelled | — | — | 17.3 | 1.46 |
| 3 | 23.89 | 189.9 | 5.5 | 16.3 | 0.40 |
| 4 | 25.82 | 340.3 | 5.5 | 13.9 | 2.27 |
| 5 | Gelled | — | — | 12.3 | 1.04 |
| 6 | Gelled | — | — | 11.3 | 0.28 |
| 7 | 32.93 | 56.94 | 6.5 | 12.2 | 1.99 |
| 8 | Separated | — | — | 10.7 | 0.9 |
| 9 | Separated | — | — | 9.7 | 0.24 |
| 10 | 22.73 | 281.5 | 7 | 8.9 | 1.45 |
| 11 | Separated | — | — | 7.6 | 0.64 |

It is noted that some of the polyurethane binders did not form stable dispersions. With particular reference to the particles prepared with higher molecular weight PLACCEL®-type monomer, e.g., Binders 4-11 with Mw from 1000 g/mol to 2000 g/mol, the stable dispersions that were prepared that had a higher weight percentage of isocyanate groups that were not reacted with available hydroxyl groups during polymerization, e.g., having a higher NCO:OH molar ratio. In further detail, the stable dispersions had an excess NCO component with the polyurethane polymer ranging from 1.45 wt % to 2.27 wt %. The formulations of 1000 g/mol or more that gelled or separated had an excess NCO component ranging from 0.25 to 1.04 wt %. Thus, the trend tended to be, particularly for some of the larger molecular weight diols, that a slightly larger excess of NCO tended to enhance stability. As Binders 1, 3, 4, 7, and 10 formed stable dispersions, and their preparation is described in Examples 2-6 below.

### Example 2—Synthesis of Polyurethane Binder 1

Polyurethane Binder 1 was made by the following procedure. 40.314 grams of diol (PLACCEL® 205, 525 g/mol or Mw, from Daicel ChemTech Inc., U.S.A.), and 44.372 grams of isophorone diisocyanate (IPDI) in 80 grams of acetone were mixed in a 500 mL 4-neck round bottom flask. A mechanical stirrer with glass rod and Teflon blade was attached. A condenser was attached. The flask was immersed in a constant temperature bath at 75° C. The system was kept under a drying tube. 3 drops of dibutyltin dilaurate (DBTDL) were added to initiate the polymerization. Polymerization was continued for 6 hours at 75° C. 0.5 gram samples were withdrawn for wt % NCO titration to confirm the reaction. The measured NCO value was 12.10 wt %. Theoretical wt % NCO should be 12.18 wt %. The polymerization temperature was reduced to 50° C. 8.889 grams of isophorone diamine (IPDA), 12.852 grams of sodium aminoalkylsulphonate (A-95™, Evonik, Germany, 50 wt % in water) and 32.129 grams of deionized water were mixed in a beaker until completely dissolved. The IPDA and A-95™ solution was added to the pre-polymer solution at 50° C. with vigorous stirring over 5 minutes. The solution became viscous and slight hazy. The mixture was stirred for 30 minutes at 50° C. Then 192.685 grams of cold deionized water was added to the polymer mixture in the 4-neck round bottom flask over 10 minutes with good agitation to form a polyurethane dispersion. The agitation was continued for 60 minutes at 50° C. The dispersion was filtered through a 400 mesh stainless sieve. Acetone was removed with rotorvap at 50° C. (adding 2 drops (20 mg) BYK-011 de-foaming agent). The final polyurethane dispersion was filtered through fiber glass filter paper. The D50 particle size measured by Malvern ZETASIZER™ (Malvern Panalytical, United Kingdom) was 70.15 nm. The pH was 5.5. Solid content was 30.74 wt %.

### Example 3—Synthesis of Polyurethane Binder 3

48.741 grams of polycaprolactone polyol (PLACCEL™ 205, 525 g/mol or Mw, from Daicel ChemTech, U.S.A.), and 38.107 grams of isophorone diisocyanate (IPDI) in 80 grams of acetone were mixed in a 500 mL 4-neck round bottom flask. A mechanical stirrer with glass rod and Teflon blade was attached. A condenser was attached. The flask was immersed in a constant temperature bath at 75° C. The system was kept under a drying tube. 3 drops of dibutyltin dilaurate (DBTDL) were added to initiate the polymerization. Polymerization was continued for 6 hours at 75° C. 0.5 gram samples were withdrawn for wt % NCO titration to confirm the reaction. The measured NCO value was 12.10 wt %. Theoretical wt % NCO should be 12.18 wt %. The polymerization temperature was reduced to 50° C. 7.634 grams of isophorone diamine (IPDA), 11.037 grams of sodium aminoalklysulphonate (A-95™, Evonik, Germany, 50 wt % in water) and 27.692 grams of deionized water were mixed in a beaker until completely dissolved. The IPDA and A-95™ solution was added to the pre-polymer solution at 50° C. with vigorous stirring over 5 minutes. The solution became viscous and slight hazy. The mixture was stirred for 30 minutes at 50° C. Then 195.060 grams of cold deionized water was added to the polymer mixture in the 4-neck round bottom flask over 10 minutes with good agitation to form a polyurethane dispersion. The agitation was continued for 60 minutes at 50° C. The dispersion was filtered through a 400 mesh stainless sieve. Acetone was removed with rotorvap at 50° C. (adding 2 drops (20 mg) BYK-011 de-foaming agent). The final polyurethane dispersion was filtered through fiber glass filter paper. The D50 particle size measured by Malvern ZETASIZER™ (Malvern Panalytical, United Kingdom) was 189.9 nm. The pH was 5.5. Solid content was 23.89 wt %.

### Example 4—Synthesis of Polyurethane Binder 4

56.265 grams of diol (PLACCEL® 210N, 1000 g/mol or Mw, from Daicel ChemTech, U.S.A.), and 32.513 grams of isophorone diisocyanate (IPDI) in 80 grams of acetone were mixed in a 500 mL 4-neck round bottom flask. A mechanical stirrer with glass rod and Teflon blade was attached. A condenser was attached. The flask was immersed in a constant temperature bath at 75° C. The system was kept under a drying tube. 3 drops of dibutyltin dilaurate (DBTDL) were added to initiate the polymerization. Polymerization was continued for 6 hours at 75° C. 0.5 gram samples were withdrawn for wt % NCO titration to confirm the reaction. The measured NCO value was 8.50 wt %. Theoretical wt % NCO should be 8.52 wt %. The polymerization temperature was reduced to 50° C. 6.513 grams of isophorone diamine (IPDA), 9.417 grams of sodium aminoalkylsulphonate (A-95™, Evonik, Germany, 50 wt % in water) and 23.542 grams of deionized water were mixed in a beaker until completely dissolved. The IPDA and A-95™ solution was added to the pre-polymer solution at 50° C. with vigorous stirring over 5 minutes. The solution became viscous and slight hazy. The mixture was continued to stir for 30 minutes at 50° C. Then 197.179 grams of cold deionized water was added to the polymer mixture in a 4-neck round bottom flask over 10 minutes with good agitation to form a polyurethane dispersion. The agitation was continued for 60 minutes at 50° C. The dispersion was filtered through a 400 mesh stainless sieve. Acetone was removed with rotorvap at 50° C. (adding 2 drops (20 mg) BYK-011 de-foaming agent). The final polyurethane dispersion was filtered through fiber glass filter paper. The D50 particle size measured by Malvern ZETASIZER™ (Malvern Panalytical, United Kingdom) was 340.3 nm. The pH was 5.5. Solid content was 25.82 wt %.

### Example 5—Synthesis of Polyurethane Binder 7

61.659 grams of polycaprolactone polyol (PLACCEL® L212AL, 1250 g/mol or Mw, Daicel ChemTech, Inc., U.S.A.), and 28.504 grams of isophorone diisocyanate (IPDI) in 80 grams of acetone were mixed in a 500 mL 4-neck round bottom flask. A mechanical stirrer with glass rod and Teflon blade was attached. A condenser was attached. The flask was immersed in a constant temperature bath at 75° C. The system was kept under a drying tube. 3 drops of dibutyltin dilaurate (DBTDL) were added to initiate the polymerization. Polymerization was continued for 6 hours at 75° C. 0.5 gram samples were withdrawn for wt % NCO titration to confirm the reaction. The measured NCO value was 7.30 wt %. Theoretical wt % NCO should be 7.35 wt %. The polymerization temperature was reduced to 50° C. 5.710 grams of isophorone diamine (IPDA), 8.256 grams of sodium aminoalklysulphonate (A-95™, Evonik, Germany, 50 wt % in water) and 20.639 grams of deionized water were mixed in a beaker until completely dissolved. The IPDA and A-95™ solution was added to the pre-polymer solution at 50° C. with vigorous stirring over 5 minutes. The solution became viscous and slight hazy. The mixture was stirred for 30 minutes at 50° C. Then 198.699 grams of cold deionized water was added to the polymer mixture in the 4-neck round bottom flask over 10 minutes with good agitation to form a polyurethane dispersion. The agitation was continued for 60 minutes at 50° C. The dispersion was filtered through a 400 mesh stainless sieve. Acetone was removed with rotorvap at 50° C. (adding 2 drops (20 mg) BYK-011 de-foaming agent). The final polyurethane dispersion was filtered through fiber glass filter paper. The D50 particle size measured by Malvern ZETASIZER™ (Malvern Panalytical, United Kingdom) was 56.94 nm. The pH was 6.5. Solid content was 32.93 wt %.

### Example 6—Synthesis of Polyurethane Binder 10

72.013 grams of diol (PLACCEL® 220EB, 2000 g/mol or Mw, Daicel ChemTech, Inc., U.S.A.), and 20.806 grams of isophorone diisocyanate (IPDI) in 80 grams of acetone were mixed in a 500 mL 4-neck round bottom flask. A mechanical stirrer with glass rod and Teflon blade was attached. A condenser was attached. The flask was immersed in a constant temperature bath at 75° C. The system was kept under a drying tube. 3 drops of dibutyltin dilaurate (DBTDL) were added to initiate the polymerization. Polymerization was continued for 6 hours at 75° C. 0.5 gram samples were withdrawn for wt % NCO titration to confirm the reaction. The measured NCO value was 5.19 wt %. Theoretical wt % NCO should be 5.21 wt %. The polymerization temperature was reduced to 50° C. 4.168 grams of isophorone diamine (IPDA), 6.026 grams of sodium aminoalklysulphonate (A-95™, Evonik, Germany, 50 wt % in water) and 15.065 grams of deionized water were mixed in a beaker until completely dissolved. The IPDA and A-95™ solution was added to the pre-polymer solution at 50° C. with vigorous stirring over 5 minutes. The solution became viscous and slight hazy. The mixture was stirred for 30 minutes at 50° C. Then 201.616 grams of cold deionized water was added to the polymer mixture in the 4-neck round bottom flask over 10 minutes with good agitation to form a polyurethane dispersion. The agitation was continued for 60 minutes at 50° C. The dispersion was filtered through a 400 mesh stainless sieve. Acetone was removed with rotorvap at 50° C. (adding 2 drops (20 mg) BYK-011 de-foaming agent). The final polyurethane dispersion was filtered through fiber glass filter paper. The D50 particle size measured by Malvern ZETASIZER™ (Malvern Panalytical, United Kingdom) was 281.5 nm. The pH was 7. Solid content was 22.73 wt %.

### Example 7—Ink Compositions

Several Sample ink compositions (Inks 1-4) were prepared using the biodegradable polyurethane binders 1, 3, 7, and 10. The ink compositions included 6 wt % of the respective biodegradable polyurethane binder dispersion, 6 wt % glycerol as an organic co-solvent, 0.5 wt % of CRODAFOS® N3 Acid (available from Croda Personal Care, United Kingdom), 1 wt % of LIPONIC® EG-1 as an organic co-solvent (available from Vantage Specialty Chemicals, Illinois), 0.22 wt % of ACTICIDE® B20 biocide (available from Thor, United Kingdom), 0.3 wt % of SURFYNOL® 440 surfactant (available from Evonik, Germany), and 3 wt % HPF-M046 magenta pigment dispersion (available from DIC Corporation, Japan) as a colorant. The difference between the ink compositions was the selection of the polyurethane binder.

A control ink composition (Ink C) was also prepared as a comparative example that included 6 wt % IMPRANIL® DLN-SD (available from Covestro AG, Germany) as the binder. The comparative IMPRANIL® DLN-SD binder does not contain a polyurethane binder of the type described herein, but rather is a commercially available polyurethane having a weight average molecular weight of about 133,000 Mw, a measured Acid Number 5.2 mg KOH/g, a glass transition temperature of about Tg—47° C., and a melting point of about 175-200° C.

### Example 8—Washfastness

The sample ink compositions of Example 7 were printed onto gray cotton fabric using a test inkjet printer. The ink was printed without using any separate crosslinker or fixer compositions. The printed samples were cured by heating at 150° C. for 3 minutes. After printing and heat curing, the printed images were measured initially for optical density (OD). Optical density was measured herein using an X-RITE™ Spectrodensitometer (X-Rite Corporation, U.S.A.), such as a Series 500 Densitometer.

To test washfastness, the cured samples were then washed for 5 cycles using a washing machine at 40° C. with detergent and then air dried in between cycles. The OD after 5 washes was again measured using the same instrument. The % change in optical density (ΔOD) and ΔE values collected to compare the samples before washing and the samples after washing. The OD data and the ΔE CIE (1976) values are reported in Table 3, which provides washfastness data for the inks.

TABLE 3
Washfastness

| | | OD | OD | | |
|---|---|---|---|---|---|
| | | Before | After 5 | ΔOD | ΔE |
| Ink ID | Binder ID | Wash | Washes | (%) | CIE |
| Ink 1 | 1 | 0.921 | 0.824 | −10.5 | 4.8 |
| Ink 2 | 3 | 0.941 | 0.869 | −7.7 | 4.7 |
| Ink 3 | 7 | 0.953 | 0.893 | −6.3 | 3.4 |
| Ink 4 | 10 | 0.983 | 0.974 | −0.9 | 1.9 |
| Ink C | IMPRANIL ® | 0.992 | 0.849 | −14.4 | 7.8 |
| | DLN-SD | | | | |

The washfastness data in Table 3 demonstrate that the inks provided good washfastness when used without fixer or crosslinker compositions. Polyurethane binder 10 in particular provided good durability. All of Inks 1-4 outperformed Ink C containing the comparative polyurethane binder.

### Example 9—Ink Composition Stability

An Accelerated Shelf Life (ASL) test was performed for the ink compositions described above. For the ASL test, the data was collected for the ink compositions before and after 1 week of storage at 60° C. The % Δdata below relates to a comparison prior to ASL storage and after 1 week of storage. The data are shown in Table 4. Viscosity refers to the fluid viscosity of the ink compositions, which can be measured at a shear rate of 3,000 Hz, e.g., with a VISCOLITE® Viscometer from Hydramotion (USA). pH refers to the pH of the ink composition and can be measured using an ACCUMET® XL250 pH meter, from Fisher Scientific (U.S.A.); My refers to Volume Averaged D50 Particle Size; and D95 refers to the 95 Percentile Particle Size.

TABLE 4
Ink Stability

| | | ASL (1 week at 60° C.) | | | |
|---|---|---|---|---|---|
| | | Δ % | | Δ % | Δ % |
| Ink ID | Binder ID | Viscosity | Δ pH | Mv | D95 |
| Ink 1 | 1 | 0.0 | −0.02 | −1.2 | −1.6 |
| Ink 2 | 3 | −1.0 | −0.003 | −0.5 | −2.0 |
| Ink 3 | 7 | 0.0 | −0.07 | −2.7 | −8.0 |
| Ink 4 | 10 | −5.0 | 0.01 | −0.3 | −1.5 |
| Ink C | IMPRANIL ® | −12.5 | −0.11 | −11 | −33.1 |
| | DLN-SD | | | | |

The ASL data in Table 4 above shows that all of the inks had good ink stability. All of Inks 1-4 outperformed Ink C containing the comparative polyurethane binder.

### Example 10—Print Performance

The ink compositions were evaluated for print performance using a thermal inkjet pen (A3410, available from HP, Inc., California). The data was collected according to the following procedures:

Decap is determined using the indicated time (1 second or 7 seconds) where nozzles remain open (uncapped), and then the number of lines missing (or line spits until a good line is printed) during a print event are recorded. Thus, the lower the number the better for decap performance.

Percent (%) Missing Nozzles is calculated based on the number of nozzles incapable of firing at the beginning of a jetting sequence as a percentage of the total number of nozzles on an inkjet printhead attempting to fire. Thus, the lower the percentage number, the better the Percent Missing Nozzles value.

Drop Weight (DW) is an average drop weight in nanograms (ng) across the number of nozzles fired measured using a burst mode or firing at 0.75 Joules.

Drop Weight 2,000 (DW 2K) is measured using a 2-drop mode of firing, firing 2,000 drops and then measuring/calculating the average ink composition drop weight in nanograms (ng).

Drop Velocity (DV) refers to an average velocity of the drop as initially fired from the thermal inkjet nozzles.

Decel refers to the loss in drop velocity after 5 seconds of ink composition firing.

The decap, missing nozzles, drop weight, drop volume, and decel data is shown in Table 5.

TABLE 5

| | | Decap | Decap | Miss. Noz. | DW | DW 2k | DV | |
|---|---|---|---|---|---|---|---|---|
| Ink ID | Binder ID | (1 s) | (7 s) | (%) | (ng) | (ng) | (m/s) | Decel |
| Ink 1 | 1 | 11 | 22 | 8.3 | 12.2 | 12.2 | 11.0 | 0.2 |
| Ink 2 | 3 | 8 | 22 | 85.4 | — | — | — | — |
| Ink 3 | 7 | 9 | 14 | 3.1 | 11.0 | 12.5 | 12.1 | 0.2 |
| Ink 4 | 10 | 8 | 15 | 5.5 | 10.7 | 12.3 | 12.0 | 0.0 |
| Ink C | IMPRANIL ® | 7 | 21 | 3.1 | 12.0 | 9.6 | 12.0 | 0.0 |
| | DLN-SD | | | | | | | |

The ink with binders 1, 7, and 10 were found to have good print performance. Ink 2 (with Binder 3) was not as good with respect to missing nozzle performance, and thus the drop weight, drop velocity, and decel were not measured.

What is claimed is:

1. An ink composition, comprising:
water;
an organic co-solvent;
a colorant; and
a biodegradable polyurethane binder comprising:
prepolymer segments including polymerized monomers of a diisocyanate and a diol, wherein the diol comprises two terminal 6-hydroxyhexanoate groups linked by an organic linking group, and
chain extenders connecting the prepolymer segments, wherein the chain extenders include a polymerized diamine.

2. The ink composition of claim 1, wherein the polymerized diamine comprises a polymerized sulfonate-containing diamine and a polymerized non-ionic diamine.

3. The ink composition of claim 1, wherein the diol has the structure: 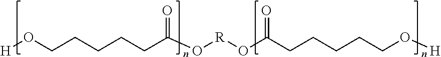
wherein R is a straight or branched alkyl chain having from 2 to 20 carbons and wherein n is an integer from 1 to 20.

4. The ink composition of claim 1, wherein the diol has a weight average molecular weight from 300 g/mol to 3,000 g/mol.

5. The ink composition of claim 1, wherein the diol has a weight average molecular weight from 1000 g/mol to 3,000 g/mol, and includes an excess of isocyanate groups from 1.25 wt % to 4 wt % based on a total weight of the biodegradable polyurethane binder.

6. The ink composition of claim 1, wherein the diisocyanate and the diol are included at a NCO:OH molar ratio from 1.01:1 to 3:1, and the biodegradable polyurethane binder has a D50 particle size from 50 nm to 350 nm.

7. The ink composition of claim 1, wherein the diisocyanate comprises 2,2,4-trimethylhexane-1,6-diisocyanate (TMDI); 2,4,4-trimethylhexane-1,6-diisocyanate (TMDI); isophorone diisocyanate (IPDI); 1,3-bis(isocyanatomethyl)cyclohexane (H6XDI); hexamethylene diisocyanate (HDI); methylene diphenyl diisocyanate (MDI); 4,4′-methylene dicyclohexyl diisocyanate (H12MDI); or a combination thereof.

8. The ink composition of claim 1, wherein the polyurethane binder has an acid number from 6 mg KOH/g to 30 mg KOH/g.

9. A textile printing system, comprising:
a fabric substrate; and
an inkjet printhead in fluid communication with a reservoir containing an ink composition to eject the ink composition, the ink composition comprising:
water,
an organic co-solvent,
a colorant, and
a biodegradable polyurethane binder comprising:
prepolymer segments including polymerized monomers of a diisocyanate and a diol, wherein the diol comprises two terminal 6-hydroxyhexanoate groups linked by an organic linking group, and
chain extenders connecting the prepolymer segments, wherein the chain extenders include a polymerized diamine.

10. The textile printing system of claim 9, wherein the fabric substrate includes cotton, polyester, silk, nylon, or a blend thereof.

11. The textile printing system of claim 9, wherein the polymerized diamine comprises a polymerized sulfonate-containing diamine and a polymerized non-ionic diamine.

12. A method of textile printing, comprising:
jetting an ink composition onto a fabric substrate, the ink composition comprising:
water,
an organic co-solvent,
a colorant, and
a biodegradable polyurethane binder comprising:
prepolymer segments including polymerized monomers of a diisocyanate and a diol, wherein the diol comprises two terminal 6-hydroxyhexanoate groups linked by an organic linking group, and
chain extenders connecting the prepolymer segments, wherein the chain extenders include a polymerized diamine.

13. The method of claim 12, further comprising applying a crosslinker composition onto the fabric substrate before jetting the ink composition.

14. The method of claim 12, wherein the fabric substrate includes cotton, polyester, silk, nylon, or a blend thereof.

15. The method of claim 12, wherein the polymerized diamine comprises a polymerized sulfonate-containing diamine and a polymerized non-ionic diamine.
